(19) United States
(12) Patent Application Publication
(10) Pub. No.: US 2008/0030581 A1
(43) Pub. Date: Feb. 7, 2008

(54) Multizone Color Doppler Beam Transmission Method

(75) Inventor: Keith W. Johnson, Lynnwood, WA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,096

(22) PCT Filed: Apr. 15, 2005
(86) PCT No.: PCT/IB05/51238

§ 371 Date: Oct. 19, 2006

Related U.S. Application Data
(60) Provisional application No. 60/563,608, filed on Apr. 20, 2004.

(51) Int. Cl. G01S 15/89

(52) U.S. Cl. 348/163

(57) ABSTRACT

A method is disclosed herein for producing color Doppler images of a subject. The method comprises the steps of transmitting (401) first and second transmit beams into the subject, wherein said first and second transmit beams are characterized by first and second frequencies, and wherein each of said first and second transmit beams has first and second sets of receive beams associated therewith, respectively; receiving (403) the first and second sets of receive beams; and producing (405) a composite color Doppler image based on the first and second sets of receive beams.

The present invention relates generally to ultrasound imaging, and more particularly to methods for improving near field resolution and far field sensitivity in color Doppler imaging.

Conventional sonography is conducted with the use of diagnostic ultrasound equipment that transmits sound energy into the human body and receives the signals that reflect off of bodily tissues and organs such as the heart, liver, and kidneys. Blood flow patterns may be obtained from Doppler shifts or from shifts in time domain cross correlation functions due to blood cell motion. These shifts produce reflected sound waves that may be generally displayed in a two-dimensional format known as color flow imaging or color velocity imaging. A typical ultrasound system emits pulses over a plurality of paths and converts echoes received from objects on the plurality of paths into electrical signals used to generate ultrasound data from which an ultrasound image can be displayed. The process of obtaining the raw data from which the ultrasound data is produced is typically termed “scanning,” “sweeping,” or “steering a beam”.

Sonography may be performed in real time, which refers to the presentation of ultrasound images in a rapid sequential format as the scanning is being performed. Typically, the scanning that gives rise to the image is performed electronically, and utilizes a group of transducer elements (called an “array”) which are arranged in a line and which are excited by a set of electrical pulses, one pulse per element. The pulses are typically timed to construct a sweeping action.

Signal processing in an ultrasound scanner usually begins with the shaping and delaying of the excitation pulses applied to each element of the array so as to generate a focused, steered and apodized pulsed wave that propagates into the tissue. The characteristics of the transmitted acoustic pulse may be adjusted or “shaped” to correspond to the setting of a particular imaging mode. For example, pulse shaping may include adjusting the length of the pulse for different lines depending on whether the returned echoes are ultimately to be used in B-scan, pulsed Doppler or color Doppler imaging modes. Pulse shaping may also include adjustments to the central frequency which, in modern broadband transducers, can be set over a wide range and may be selected according to the part of the body that is being scanned. A number of scanners also shape the envelope of the pulse (i.e., by making it Gaussian in shape) to improve the propagation characteristics of the resulting sound wave.

Echoes resulting from scattering of the sound by tissue structures are received by all of the elements within the transducer array and are subsequently processed. The processing of these echo signals typically begins at the individual channel or element level with the application of apodization functions, dynamic focusing, steering delays, and other such procedures.

One of the most important elements in signal processing is beam forming. In a transducer array, the beam is focused and steered by exciting each of the transducer elements at a different time so that the resulting sound wave coming from each element will arrive at the intended focal point simultaneously.

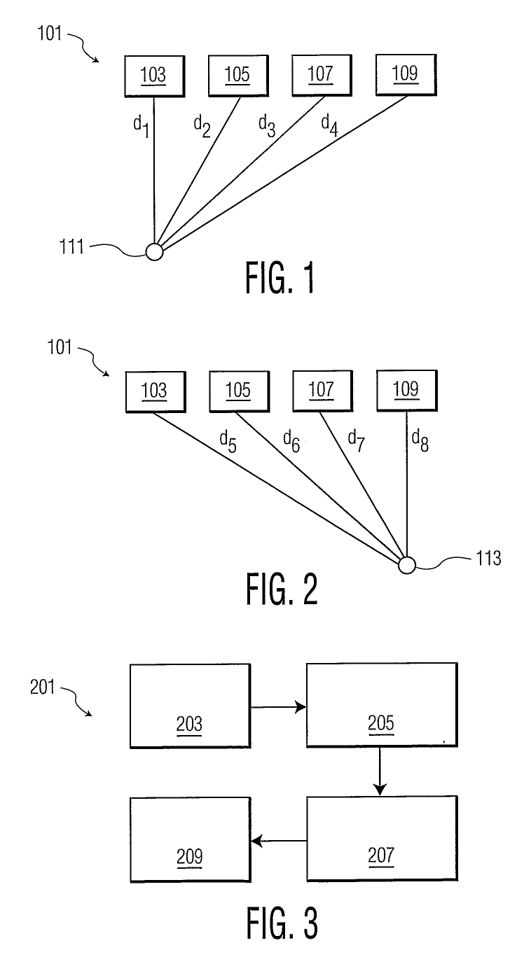

This principle may be understood in reference to FIG. 1, which depicts a transducer array 101 having transducers 103, 105, 107 and 109 that are at distances d₁, d₂, d₃ and d₄, respectively, from focal point 111. In the case depicted, the beam is being focused and steered to the left. Since the distance d₁ from the focal point to transducer element 103 of the transducer array is shorter than the distance d₄ from the focal point to transducer element 109, during transmission, element 109 must be excited before elements 103, 105, and 107 in order for the waves generated by each element to arrive at the focal point simultaneously. By contrast, in the case shown in FIG. 2, the focal point 113 is to the right. Here, the elements of the transducer must be excited in the reverse order during transmission (that is, element 103 must be excited before elements 105, 107, and 109) in order for the waves generated by each element to arrive at the focal point simultaneously. This process of coordinating the firing of transducer elements is referred to as “beam formation”, and the device which implements this process is called a “beam former”.

Beam forming is typically implemented during both transmission (described above) and reception. Beam forming on reception is conceptually similar to beam forming on transmission. On reception, an echo returning from a given point 111 (see FIG. 1) encounters each of the elements 103, 105, 107 and 109 in the transducer array 101 at a different time due to the varying distances d₁, d₂, d₃ and d₄, respectively, of these elements from focal point 111. Consequently, the signals coming into the ultrasound scanner from the various elements must be delayed so that they all “arrive” at the same moment. The signals from each element are then summed together to form the ultrasound signal that is subsequently processed by the rest of the ultrasound instrument. Typically, 1-dimensional arrays having 32 to 192 transducer elements are used for beam formation. The signal from each individual element is delayed in order to steer the beam in the desired direction.

The beam former, in addition to combining the received signals into an output signal, also focuses the beam. When dynamic focusing is used, for each pulse which is transmitted from the array, the beam former tracks the depth and focuses the receive beam as the depth increases. The receive aperture will usually be allowed to increase with depth, since this achieves a lateral resolution which is constant with depth and decreases sensitivity to aberrations in the imaged medium. In order for the receive aperture to increase with depth, it is necessary to dynamically control the number of elements in the array that are used to receive the echoes. Since often a weighting function (apodization) is used to reduce or eliminate side lobes from the combined signal, the element weights also have to be dynamically updated with depth.

Most ultrasound scanners are able to perform parallel beam forming. Parallel beam forming refers to the acquisition of multiple roundtrip beams from a single transmit event by focusing multiple receive beams within a single transmit beam. The transmit beam, due to its single focus, is typically apodized to improve depth of field and is therefore inherently wider than the dynamically focused receive beams. The receive beams have local acoustical maxima which are off-axis relative to the transmit beam. Parallel beam forming allows the imaged field to be scanned faster and thus allows the frames to be updated faster. Parallel beam forming is especially advantageous in 3-D imaging, due to the large number of frames that need to be gathered.

While the use of beam formers and beam forming procedures has significantly improved the quality of acoustical images, a number of challenges remain in the art. In particular, current acoustical imaging technology typically requires a tradeoff between near field resolution (usually provided by higher frequencies, and typically confined to the first centimeter or so of depth in the subject) and far field sensitivity (usually provided by lower frequencies). Consequently, for example, while significant improvements have been made in resolution of low flow velocities, these improvements have typically come at the expense of depth of field. Some approaches utilize a frequency shift, so that near field scanning is conducted at a first frequency and far field scanning is conducted at a second frequency. However, this approach is less than optimal and provides poor resolution of features that have significant depth of field. This type of approach also frequently produces imaging artifacts.

There is thus a need in the art for a method for improving the resolution of color Doppler imaging across the entire depth of the image. There is further a need in the art for a method for improving near field resolution and far field sensitivity in color Doppler imaging. These and other needs are met by the methodologies and devices disclosed herein and hereinafter described.

In one aspect, a method for producing color Doppler images of a subject is provided. The method comprises the steps of transmitting first and second transmit beams into the subject, wherein said first and second transmit beams are characterized by first and second frequencies, and wherein each of said first and second transmit beams has first and second sets of receive beams associated therewith, respectively; receiving the first and second sets of receive beams; and producing a composite color Doppler image based on the first and second sets of receive beams. The composite image may be derived from the weighted average of the first and second sets of receive beams, in which case the weighted average may be derived by applying first and second weighting factors to the first and second sets of receive beams, respectively. The first and second weighting factors may be chosen to optimize sensitivity and near field resolution.

Preferably, the first frequency is a high frequency and the second frequency is a low frequency. Even more preferably, the difference between the first and second frequencies is at least about 2 MHz, and most preferably, the difference between the first and second frequencies is within the range of about 2 MHz to about 7 MHz. Any number of additional transmit beams may be utilized that have frequencies between the frequencies of the first and second transmit beams.

The first and second frames may be derived from frequency estimates based on the first and second sets of receive beams. Put another way, the composite image, which is preferably a color Doppler image, may be derived from frequency estimates corresponding to the first and second sets of receive beams. The composite image may be formed by averaging the complex signal estimates used to produce the frequency estimate for the first set of receive beams with the complex signal estimates used to produce the frequency estimate for the second set of receive beams. Thus, for example, the first (F₁) and second (F₂) frequencies may be such that V₁=V₂, wherein
V₁=PRF₁·c/(2F₁ cos (θ)) and
V₂=PRF₂·c/(2F₂ cos (θ)), and wherein:
PRF₁ is the color Doppler pulse repetition frequency associated with F₁;
PRF₂ is the color Doppler pulse repetition frequency associated with F₂;
θ is the color Doppler angle (typically constant); and
c is the speed of sound.

In another aspect, a method for acoustically imaging a subject is provided which comprises the steps of transmitting first and second transmit beams into the subject, wherein the first and second transmit beams are characterized by first and second frequencies F₁ and F₂, respectively, wherein F₁>F₂; receiving first and second sets of receive beams corresponding, respectively, to first and second transmit beams; determining the frequencies of the first and second sets of receive beams; applying first and second weighting factors to the determined frequencies, thereby producing first and second weighted frequencies; and producing a composite color Doppler image based on the first and second weighted frequencies. Preferably, each of said first and second sets of receive beams has a plurality of members.

In still another aspect, a method is provided for producing color Doppler images of a subject. The method comprises the steps of obtaining a grey scale image frame from the subject; obtaining a first color image frame from the subject by transmitting a first transmit beam into the subject and receiving a first set of receive beams that are associated with the first transmit beam, wherein said first transmit beam is characterized by a first frequency and has a first set of receive beams associated therewith; obtaining a second color image frame from the subject by transmitting a second transmit beam into the subject, wherein said second transmit beam is characterized by a second frequency and has a second set of receive beams associated therewith, wherein said second frequency is distinct from said first frequency; receiving the first and second sets of receive beams; and producing a composite color Doppler image based on the first and second sets of receive beams.

These and other aspects of the teachings herein are described in further detail below.

For a more complete understanding of the present invention and advantages thereof, reference is now made to the following description which is to be taken in conjunction with the accompanying drawings in which like reference numbers indicate like features and wherein:

FIG. 1 is a diagram illustrating the need for time delay to account for differences in the distances between the elements of a transducer array and a focal point in an ultrasound diagnostic system;

FIG. 2 is a diagram illustrating the need for time delay to account for differences in the distances between the elements of a transducer array and a focal point in an ultrasound diagnostic system;

FIG. 3 is a flow chart illustrating the frame acquisition sequence in one embodiment of the methodology disclosed herein;

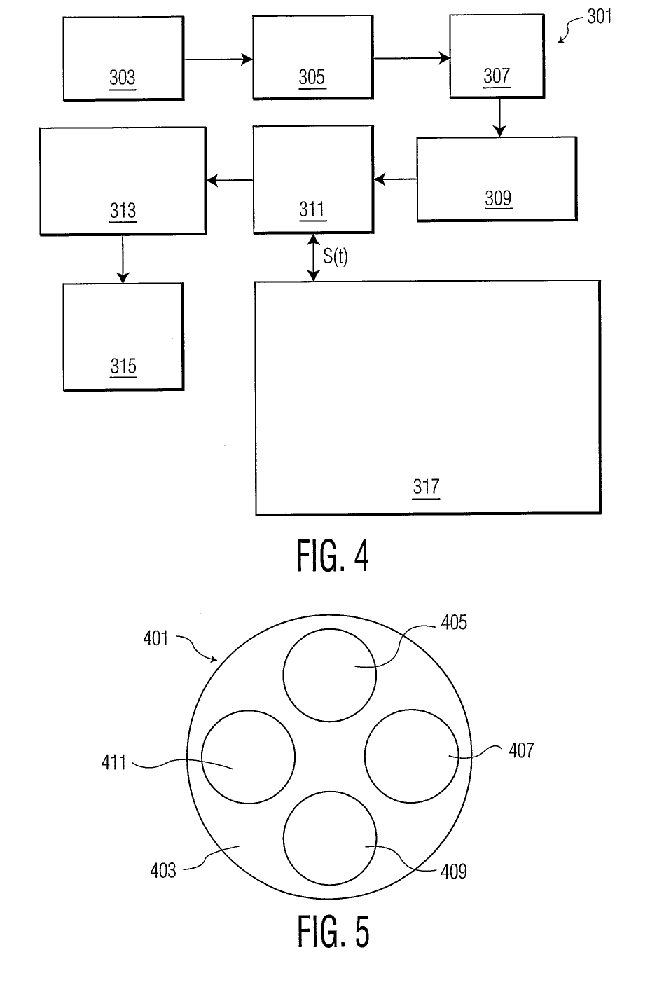

FIG. 4 is a flow chart illustrating a system for implementing the methodology disclosed herein;

FIG. 5 is an illustration of a 4-way parallel beam pattern on the receive side;

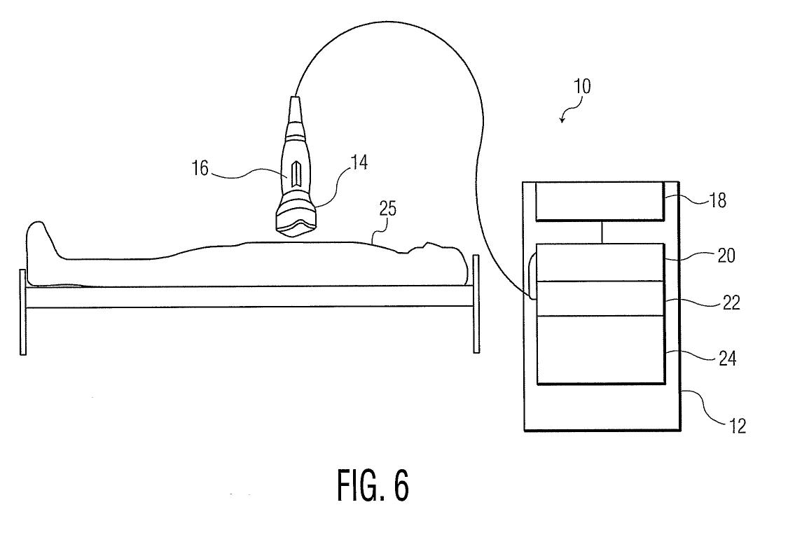

FIG. 6 is an illustration of an ultrasound device which may be used to implement the methodologies disclosed herein;

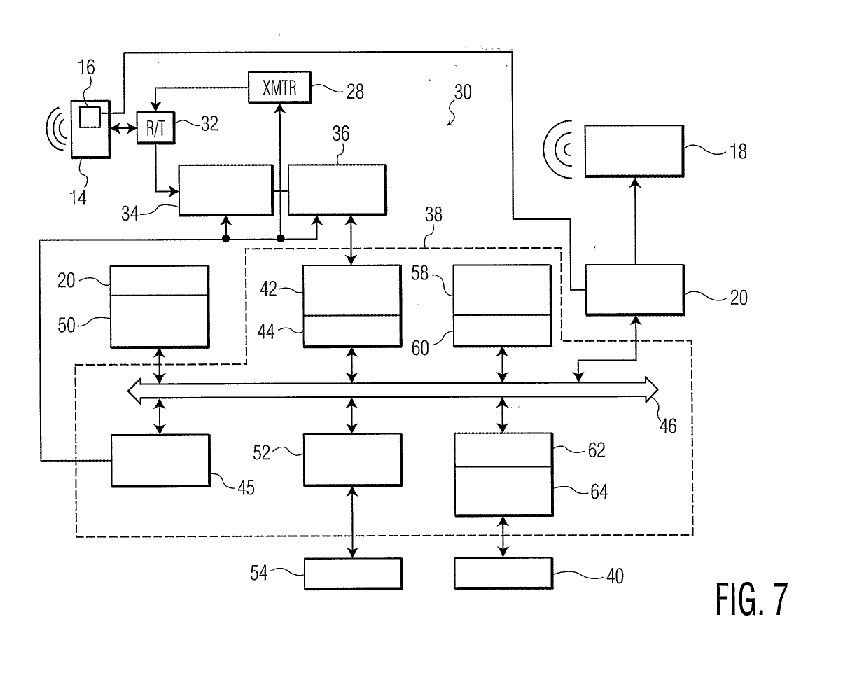

FIG. 7 is a schematic diagram illustrating the functional elements of a device of the type depicted in FIG. 6; and

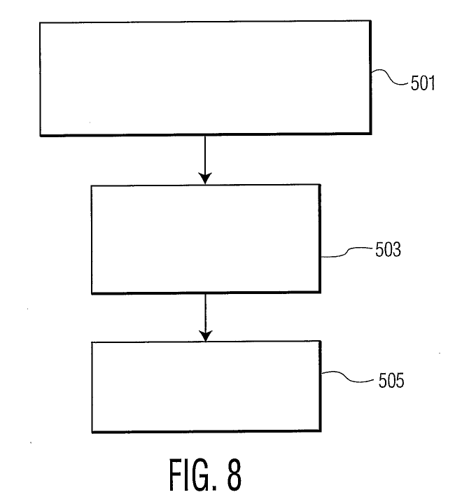

FIG. 8 is a flow chart illustrating one embodiment of the methodology disclosed herein.

It has now been found that the aforementioned needs may be met by utilizing multiple transmit beams characterized by multiple transmit and/or receive frequencies. Thus, in a preferred embodiment, first and second transmit beams are transmitted into the subject, wherein the first and second transmit beams are characterized by first and second frequencies, and wherein each of the first and second transmit beams has first and second sets of receive beams associated therewith, respectively. The first and second sets of receive beams are then received and utilized to produce a composite color Doppler image. This approach improves the resolution of color Doppler imaging across the entire depth of the image, and allows near field resolution to be improved without adversely affecting far field sensitivity.

One preferred embodiment of the methodology disclosed herein may be understood generally with reference to FIG. 3, which depicts a data acquisition sequence that could be utilized in forming a composite color Doppler image in accordance with the teachings herein. In the particular sequence 201 depicted therein, an echo frame is acquired 203, followed by the acquisition of a high frequency color frame 205 (e.g., 9 MHz, utilized for the near field) and a low frequency (e.g., 6 MHz, utilized for the far field) color frame 207. This sequence is then repeated for the remainder of the imaging process.

In alternative embodiments of this process, data acquisition may be conducted on a line-by-line basis rather than on a frame-by-frame basis. Thus, for example, in such embodiments, a line of the high frequency color frame could be gathered, followed by a line of the low frequency color frame, and this process could be repeated until an entire frame is collected. Such alternative embodiments may be undesirable in applications where substantial amounts of decaying echoes will be present that would tend to interfere with the data acquisition process.

In still other embodiments, multiple frames may be acquired at a given frequency followed by the acquisition of frames at another frequency. For example, multiple frames could be acquired at a high frequency, each frame being acquired at a different depth, followed by the acquisition of multiple frames at a lower frequency (again, each frame being acquired at a different depth).

Alternatively, the sequence shown in FIG. 3 could be utilized, but the focus depth of one or both of the frequencies utilized could change from one iteration to the next. For example, one iteration could be implemented with the high frequency (9 MHz) beam focused at 1 cm and the low frequency (6 MHz) beam focused at 4 cm, followed by the associated echo frames. A subsequent iteration could be implemented with the high frequency (9 MHz) beam focused at 2 cm and the low frequency (6 MHz) beam focused again at 4 cm. In some applications, this approach may be advantageous in that the focusing ability of the beam former may allow a given frequency to potentially realize a deeper depth.

As described in greater detail below, the high frequency color frame and the low frequency color frame may be used in conjunction with weighting functions or other such means to form a composite color Doppler image with improved resolution across the entire depth of the image, while the echo frame provides a grey-scale picture suitable for use as the background of the image.

FIG. 4 illustrates the essential elements of one non-limiting embodiment of a system 301 that may be utilized in the color Doppler imaging techniques disclosed herein. The particular system illustrated assumes the use of two transmit beams, one at high frequency and the other at low frequency, though one skilled in the art will appreciate that the techniques disclosed herein can be readily generalized to systems that utilizes more than two transmit beam frequencies.

The system includes a beam former front end 303, which transmits signals in order to form an image by shooting lines. A receiver, or Quadrature Band Pass (QBP) filter 305, receives the echoes of the transmitted signals, and converts the received signals into complex numbers that are obtained from the product of the input signal with cosine and sine signals. The resulting complex numbers are input into a clutter filter 307, which corrects for the wall motion of the subject. A power and autocorrelation function 309 is provided which takes multiple pulse repetition intervals (PRIs) and creates a complex frequency estimate from the average phase. This frequency estimate is related to the actual Doppler velocity by the Doppler equation.

The system further includes a multizone frame averaging functionality 311, a lateral interpolation and spatial averaging functionality 313, and mean frequency estimation 315 functionalities. The multizone frame averaging, by which two or more signals are essentially blended together, involves application of a complex signal estimate S(t) 317, which is given by EQUATION I:

S(t)=P*a(d)*S(t−1)+(1−P)*b(d)*S(t) (EQUATION 1)

wherein
a(d) is the depth and low frequency dependent weighting;
b(d) is the depth and high frequency dependent weighting; and
P is the frame averaging coefficient.

The use, in the frame averaging process, of low and high frequency weighting factors that are depth dependent preserves near field resolution by preventing the low frequency signal from masking the near field resolution, while also preventing the high frequency signal from causing a loss in sensitivity. The result is a reasonably continuous signal resulting from the smooth blending of the low and high frequency signals. Absent a weighting factor, signal loss is observable with the high frequency signal at a certain depth (typically on the order of a few centimeters), and the switch to a lower frequency signal produces a discontinuity.

The lateral interpolation and spatial averaging 313 functionality is provided to improve signal to noise ratio. This is preferably accomplished by averaging the signals laterally and axially. The mean frequency estimation 315 functionality derives the phase of the angle from its arctangent. The phase is then converted into a velocity.

Various options are possible to produce an even smoother transition from one signal to the other (that is, to create a more optimal blending of low and high frequency signals, in the case of a two signal solution). Thus, for example, the QDB can be operated as a function of depth to highlight the frequency present at a given depth.

As previously indicated, the methodologies described herein are not particularly limited to any number of transmit beams operating at different frequencies. However, it is preferred that there are multiple transmit beams operating at different frequencies, and that each transmit beam has multiple (for example, 4) receive beams associated with it. If two frequencies are utilized, it is preferred that the frequencies utilized are separated by at least 2 MHz but no more than 7 MHz, though larger spreads may be acceptable if additional transmit beams operating at intermediate frequencies are utilized.

The frequencies of the transmit beams in a system which utilizes transmit beams having first (F₁) and second (F₂) transmit frequencies are preferably selected such that, for the respective velocities V₁ and V₂, the condition

V₁=V₂ (EQUATION 2)

is true, wherein

V₁=PRF₁·c/(2F₁ cos (θ)) (EQUATION 3)

and

V₂=PRF₂·c/(2F₂ cos (θ)) (EQUATION 4)

and wherein:
PRF₁ is the color Doppler pulse repetition frequency associated with F₁;
PRF₂ is the color Doppler pulse repetition frequency associated with F₂;
θ is the color Doppler angle (typically constant); and
c is the speed of sound.

FIG. 5 illustrates one specific, non-limiting example of a beam pattern 401 that can be employed in the imaging methodologies disclosed herein. The beam pattern has not been drawn to scale. The beam pattern is a 4-way parallel beam pattern that includes a transmit beam 403 and receive beams 405, 407, 409 and 411. In a typical embodiment of the methodologies disclosed herein, multiple transmit beams will be utilized, each of which may have a beam pattern of the type illustrated.

In some embodiments, the integrated energy of receive beams 405 and 409 may be compared in order to determine which way, if any, to adjust the center of each receive aperture in the elevation direction, should any adjustments be necessary to compensate for occlusions. Similarly, the integrated energy of receive beams 407 and 411 may be compared in order to determine which way, if any, to adjust the center of each receive aperture laterally.

FIG. 6 shows a simplified block diagram of one possible ultrasound imaging system 10 that may be used in the implementation of the methodologies disclosed herein. It will be appreciated by those of ordinary skill in the relevant arts that the ultrasound imaging system 10, as illustrated in FIG. 6, and the operation thereof as described hereinafter, is intended to be generally representative of such systems and that any particular system may differ significantly from that shown in FIG. 6, particularly in the details of construction and in the operation of such system. As such, the ultrasound imaging system 10 is to be regarded as illustrative and exemplary, and not limiting, as regards the methodologies and devices described herein or the Claims attached hereto.

The ultrasound imaging system 10 generally includes an ultrasound unit 12 and a connected transducer 14. The transducer 14 includes a spatial locator receiver 16. The ultrasound unit 12 has integrated therein a spatial locator transmitter 18 and an associated controller 20. The controller 20 provides overall control of the system by providing timing and control functions. The control routines include a variety of routines that modify the operation of the receiver 16 so as to produce a volumetric ultrasound image as a live real-time image, a previously recorded image, or a paused or frozen image for viewing and analysis.

The ultrasound unit 12 is also provided with an imaging unit 22 for controlling the transmission and receipt of ultrasound, and an image processing unit 24 for producing a display on a monitor (See FIG. 7). The image processing unit 24 contains routines for rendering a three-dimensional image. The transmitter 18 is preferably located in an upper portion of ultrasound unit 12 so as to obtain a clear transmission to the receiver 16. Although not specifically illustrated, the ultrasound unit described herein may be configured in a cart format.

During freehand imaging, a technician moves the transducer 14 over the subject 25 in a controlled motion. The ultrasound unit 12 combines image data produced by the imaging unit 22 with location data produced by the controller 20 to produce a matrix of data suitable for rendering onto a monitor (see FIG. 7). The ultrasound imaging system 10 integrates image rendering processes with image processing functions using general purpose processors and PC-like architectures. On the other hand, use of ASICs to perform the stitching and rendering is possible.

FIG. 7 is a block diagram 30 of an ultrasound system that may be used in the practice of the methodologies disclosed herein. The ultrasound imaging system shown in FIG. 11 is configured for the use of pulse generator circuits, but could be equally configured for arbitrary waveform operation. The ultrasound imaging system 10 uses a centralized architecture suitable for the incorporation of standard personal computer (“PC”) type components and includes a transducer 14 which, in a known manner, scans an ultrasound beam, based on a signal from a transmitter 28, through an angle. Backscattered signals or echoes are sensed by the transducer 14 and fed, through a receive/transmit switch 32, to a signal conditioner 34 and, in turn, to a beam former 36. The transducer 14 includes elements which are preferably configured as a steerable, two-dimensional array. The signal conditioner 34 receives backscattered ultrasound signals and conditions those signals by amplification and forming circuitry prior to their being fed to the beam former 36. Within the beam former 36, ultrasound signals are converted to digital values and are configured into “lines” of digital data values in accordance with amplitudes of the backscattered signals from points along an azimuth of the ultrasound beam.

The beam former 36 feeds digital values to an application specific integrated circuit (ASIC) 38 which incorporates the principal processing modules required to convert digital values into a form more conducive to video display that feeds to a monitor 40. A front end data controller 42 receives lines of digital data values from the beam former 36 and buffers each line, as received, in an area of the buffer 44. After accumulating a line of digital data values, the front end data controller 42 dispatches an interrupt signal, via a bus 46, to a shared central processing unit (CPU) 48. The CPU 48 executes control procedures 50 including procedures that are operative to enable individual, asynchronous operation of each of the processing modules within the ASIC 38. More particularly, upon receiving an interrupt signal, the CPU 48 feeds a line of digital data values residing in a buffer 42 to a random access memory (RAM) controller 52 for storage in random access memory (RAM) 54 which constitutes a unified, shared memory. RAM 54 also stores instructions and data for the CPU 48 including lines of digital data values and data being transferred between individual modules in the ASIC 38, all under control of the RAM controller 52.

The transducer 14, as mentioned above, incorporates a receiver 16 that operates in connection with a transmitter 28 to generate location information. The location information is supplied to (or created by) the controller 20 which outputs location data in a known manner. Location data is stored (under the control of the CPU 48) in RAM 54 in conjunction with the storage of the digital data value.

Control procedures 50 control a front end timing controller 45 to output timing signals to the transmitter 28, the signal conditioner 34, the beam former 36, and the controller 20 so as to synchronize their operations with the operations of modules within the ASIC 38. The front end timing controller 45 further issues timing signals which control the operation of the bus 46 and various other functions within the ASIC 38.

As previously noted, control procedures 50 configure the CPU 48 to enable the front end data controller 44 to move the lines of digital data values and location information into the RAM controller 52, where they are then stored in RAM 54. Since the CPU 48 controls the transfer of lines of digital data values, it senses when an entire image frame has been stored in RAM 54. At this point, the CPU 48 is configured by control procedures 50 and recognizes that data is available for operation by a scan converter 58. At this point, therefore, the CPU 48 notifies the scan converter 58 that it can access the frame of data from RAM 54 for processing.

To access the data in RAM 54 (via the RAM controller 52), the scan converter 58 interrupts the CPU 48 to request a line of the data frame from RAM 54. Such data is then transferred to a buffer 60 associated with the scan converter 58 and is transformed into data that is based on an X-Y coordinate system. When this data is coupled with the location data from the controller 20, a matrix of data in an X-Y-Z coordinate system results. A four-dimensional matrix may be used for 4-D (X-Y-Z-time) data. This process is repeated for subsequent digital data values of the image frame from RAM 54. The resulting processed data is returned, via the RAM controller 52, into RAM 54 as display data. The display data is typically stored separately from the data produced by the beam former 36. The CPU 48 and control procedures 50, via the interrupt procedure described above, sense the completion of the operation of the scan converter 58. The video processor 62 interrupts the CPU 48 which responds by feeding lines of video data from RAM 54 into the buffer 62, which is associated with the video processor 64. The video processor 64 uses video data to render a three-dimensional volumetric ultrasound image as a two-dimensional image on the monitor 40.

The above description of the invention is illustrative, and is not intended to be limiting. It will thus be appreciated that various additions, substitutions and modifications may be made to the above described embodiments without departing from the scope of the present invention. Accordingly, the scope of the present invention should be construed solely in reference to the appended Claims.

1. A method for producing color Doppler images of a subject, comprising the steps of:
transmitting first and second transmit beams into the subject, wherein said first and second transmit beams are characterized by first and second frequencies, and wherein each of said first and second transmit beams has first and second sets of receive beams associated therewith, respectively;
receiving the first and second sets of receive beams; and
producing a composite color Doppler image based on the first and second sets of receive beams.

2. The method of claim 1, wherein the composite image is produced by interleaving first and second frames derived, respectively, from the first and second sets of receive beams.

3. The method of claim 1, wherein the composite image is derived from the weighted average of the first and second sets of receive beams.

4. The method of claim 3, wherein the weighted average is derived by applying first and second weighting factors to the first and second sets of receive beams, respectively.

5. The method of claim 4, wherein the first and second weighting factors are chosen to optimize sensitivity and near field resolution.

6. The method of claim 1, wherein the first frequency is a high frequency and the second frequency is a low frequency.

7. The method of claim 1, wherein the difference between the first and second frequencies is at least about 2 MHz.

8. The method of claim 2, wherein the first and second frames are derived from frequency estimates based on the first and second sets of receive beams.

9. The method of claim 3, wherein the composite image is derived from frequency estimates corresponding to the first and second sets of receive beams.

10. The method of claim 8, wherein the composite image is formed by averaging the complex signal estimates used to produce the frequency estimate for the first set of receive beams with the complex signal estimates used to produce the frequency estimate for the second set of receive beams.

11. The method of claim 10, wherein the composite image is a color Doppler image.

12. The method of claim 11, wherein the first (F₁) and second (F₂) frequencies are such that V₁=V₂, wherein
V₁=PRF₁·c/(2F₁ cos (θ)) and
V₂=PRF₂·c/(2F₂ cos (θ)),
and wherein:
PRF₁ is the color Doppler pulse repetition frequency associated with F₁;
PRF₂ is the color Doppler pulse repetition frequency associated with F₂;
θ is the color Doppler angle; and
c is the speed of sound.

13. The method of claim 12, wherein θ is constant.

14. The method of claim 1, wherein each of the first and second sets of receive beams has a plurality of members.

15. A method for acoustically imaging a subject, comprising the steps of:
transmitting first and second transmit beams into the subject, wherein the first and second transmit beams are characterized by first and second frequencies F₁ and F₂, respectively, wherein F₁>F₂;
receiving first and second sets of receive beams corresponding, respectively, to first and second transmit beams;
determining the frequencies of the first and second sets of receive beams;
applying first and second weighting factors to the determined frequencies, thereby producing first and second weighted frequencies; and
producing a composite color Doppler image based on the first and second weighted frequencies.

16. The method of claim 15, wherein each of said first and second sets of receive beams has a plurality of members.

17. A method for producing color Doppler images of a subject, comprising the steps of:
obtaining a grey scale image frame from the subject;
obtaining a first color image frame from the subject by transmitting a first transmit beam into the subject and receiving a first set of receive beams that are associated with the first transmit beam, wherein said first transmit beam is characterized by a first frequency and has a first set of receive beams associated therewith;
obtaining a second color image frame from the subject by transmitting a second transmit beam into the subject, wherein said second transmit beam is characterized by a second frequency and has a second set of receive beams associated therewith, wherein said second frequency is distinct from said first frequency;
receiving the first and second sets of receive beams; and
producing a composite color Doppler image based on the first and second sets of receive beams.
